(19) United States
(12) Patent Application Publication
(10) Pub. No.: US 2024/0379942 A1
(43) Pub. Date: Nov. 14, 2024

(54) POSITIVE ELECTRODE FOR NONAQUEOUS ELECTROLYTE ENERGY STORAGE DEVICE, NONAQUEOUS ELECTROLYTE ENERGY STORAGE DEVICE, AND ENERGY STORAGE APPARATUS

(71) Applicant: GS Yuasa International Ltd., Kyoto-shi, Kyoto (JP)

(72) Inventor: Daisuke ENDO, Kyoto (JP)

(21) Appl. No.: 18/686,166

(22) PCT Filed: Aug. 23, 2022
(86) PCT No.: PCT/JP2022/031695

§ 371 Date: Feb. 23, 2024

(30) Foreign Application Priority Data
Aug. 30, 2021 (JP) 2021-140050

(51) Int. Cl. H01M 4/36; C01G 53/00; H01M 4/02; H01M 4/505; H01M 4/525

(52) U.S. Cl. CPC H01M 4/364; C01G 53/50; H01M 4/505; H01M 4/525; C01P 2002/50; C01P 2004/50; C01P 2004/61; C01P 2006/40; H01M 2004/021; H01M 2004/028

(57) ABSTRACT

A positive electrode for a nonaqueous electrolyte energy storage device according to one aspect of the present invention includes a first positive active material and a second positive active material having different constituent element compositions from each other, the first positive active material is at least one of primary particles that are not substantially aggregated and secondary particles that are aggregated primary particles and have a ratio of an average particle size to an average primary particle size of 5 or less, an average particle size of the first positive active material is ½ or less of an average particle size of the second positive active material, and the second positive active material is a lithium transition metal composite oxide in which a content of a lithium element with respect to a transition metal element is more than 1.0 in terms of a molar ratio.

### TECHNICAL FIELD

The present invention relates to a positive electrode for nonaqueous electrolyte energy storage device, a nonaqueous electrolyte energy storage device, and an energy storage apparatus.

### BACKGROUND ART

Nonaqueous electrolyte solution secondary batteries typified by lithium ion secondary batteries are often used for electronic devices such as personal computers and communication terminals, motor vehicles, and the like since these secondary batteries have a high energy density. As nonaqueous electrolyte solution energy storage devices other than nonaqueous electrolyte secondary batteries, capacitors such as lithium ion capacitors and electric double layer capacitors, all-solid energy storage devices, and the like are also widely used.

Heretofore, a lithium transition metal composite oxide having an a-NaFeO₂-type crystal structure has been examined as a positive active material for a nonaqueous electrolyte energy storage device, and a nonaqueous electrolyte secondary battery using LiCoO₂ has been widely put to practical use. A nonaqueous electrolyte secondary battery using a so-called LiMeO₂-type active material in which a manganese element rich in earth resources is used as a transition metal element constituting a lithium transition metal composite oxide, and a molar ratio of the lithium element with respect to the transition metal element constituting the lithium transition metal composite oxide is about 1 has also been put into practical use. On the other hand, in recent years, among lithium transition metal composite oxides having an α-NaFeO₂-type crystal structure, a so-called lithium-excess-type active material in which the molar ratio of the lithium element with respect to the transition metal element exceeds 1.0 has also been developed (see Patent Documents 1 and 2).

### PRIOR ART DOCUMENT

### Patent Documents

Patent Document 1: JP-A-2012-104335
Patent Document 2: JP-A-2013-191390

### SUMMARY OF THE INVENTION

### Problems to be Solved by the Invention

In a nonaqueous electrolyte energy storage device using a conventional positive active material for a positive electrode, it is difficult to achieve both a large initial discharge capacity per volume and a high capacity retention ratio after a charge-discharge cycle.

An object of the present invention is to provide a positive electrode for a nonaqueous electrolyte energy storage device capable of increasing an initial discharge capacity per volume of the nonaqueous electrolyte energy storage device and increasing a capacity retention ratio after a charge-discharge cycle, and a nonaqueous electrolyte energy storage device and an energy storage apparatus including such a positive electrode.

### Means for Solving the Problems

A positive electrode for a nonaqueous electrolyte energy storage device according to one aspect of the present invention includes a first positive active material and a second positive active material having different constituent element compositions from each other, the first positive active material is at least one of primary particles that are not substantially aggregated and secondary particles that are aggregated primary particles and have a ratio of an average particle size to an average primary particle size of 5 or less, an average particle size of the first positive active material is ½ or less of an average particle size of the second positive active material, and the second positive active material is a lithium transition metal composite oxide in which a content of a lithium element with respect to a transition metal element is more than 1.0 in terms of a molar ratio.

A nonaqueous electrolyte energy storage device according to another aspect of the present invention includes the positive electrode according to the one aspect of the present invention.

An energy storage apparatus according to another aspect of the present invention includes two or more nonaqueous electrolyte energy storage devices, and one or more nonaqueous electrolyte energy storage devices according to another aspect of the present invention.

### Advantages of the Invention

According to one aspect of the present invention, it is possible to provide a positive electrode for a nonaqueous electrolyte energy storage device capable of increasing an initial discharge capacity per volume of the nonaqueous electrolyte energy storage device and increasing a capacity retention ratio after a charge-discharge cycle, and a nonaqueous electrolyte energy storage device and an energy storage apparatus including such a positive electrode.

### BRIEF DESCRIPTION OF THE DRAWINGS

FIG. 1 is a see-through perspective view illustrating an embodiment of a nonaqueous electrolyte energy storage device.

FIG. 2 is a schematic diagram illustrating an embodiment of an energy storage apparatus configured by assembling a plurality of nonaqueous electrolyte energy storage devices.

### MODE FOR CARRYING OUT THE INVENTION

An embodiment of the present invention provides the following aspects.

### Item 1.

A positive electrode for a nonaqueous electrolyte energy storage device according to an embodiment of the present invention includes a first positive active material and a second positive active material having different constituent element compositions from each other, the first positive active material is at least one of primary particles that are not substantially aggregated and secondary particles that are aggregated primary particles and have a ratio of an average particle size to an average primary particle size of 5 or less, an average particle size of the first positive active material is ½ or less of an average particle size of the second positive active material, and the second positive active material is a lithium transition metal composite oxide in which a content of a lithium element with respect to a transition metal element is more than 1.0 in terms of a molar ratio.

According to the positive electrode for a nonaqueous electrolyte energy storage device described in the item 1, the initial discharge capacity per volume of the nonaqueous electrolyte energy storage device can be increased, and the capacity retention ratio after a charge-discharge cycle can be increased.

### Item 2.

In the positive electrode described in the item 1, the first positive active material may be a lithium transition metal composite oxide containing a nickel element.

According to the positive electrode described in the item 2, the initial discharge capacity per volume of the nonaqueous electrolyte energy storage device can be further increased.

### Item 3.

In the positive electrode described in the item 2, the content of the nickel element with respect to the transition metal element in the first positive active material may be 0.4 or more and 0.9 or less in terms of a molar ratio.

According to the positive electrode described in the item 3, the initial discharge capacity per volume of the nonaqueous electrolyte energy storage device can be further increased.

### Item 4.

In the positive electrode described in the item 1, item 2 or item 3, the second positive active material may contain a nickel element and a manganese element as the transition metal element, and the content of the manganese element with respect to the transition metal elements is 0.4 or more and 0.8 or less in terms of a molar ratio.

According to the positive electrode described in the item 4, the initial discharge capacity per volume of the nonaqueous electrolyte energy storage device can be further increased, and the capacity retention ratio after a charge-discharge cycle can be further increased.

### Item 5.

In the positive electrode described in any one of items 1 to 4, the average particle size of the first positive active material may be 3 μm or more and 5 μm or less, and the average particle size of the second positive active material may be 10 μm or more and 15 μm or less.

According to the positive electrode described in the item 5, the initial discharge capacity per volume of the nonaqueous electrolyte energy storage device can be increased.

### Item 6.

A nonaqueous electrolyte energy storage device according to an embodiment of the present invention includes the positive electrode described in any one of items 1 to 5.

According to the nonaqueous electrolyte energy storage device described in the item 6, the initial discharge capacity per volume of the nonaqueous electrolyte energy storage device can be increased, and the capacity retention ratio after a charge-discharge cycle can be increased.

### Item 7.

In the nonaqueous electrolyte energy storage device described in the item 6, a diffraction peak may be present in a range of 20° or more and 22° or less in an X-ray diffraction diagram of the positive electrode using a CuKα ray.

According to the nonaqueous electrolyte energy storage device described in the item 7, the capacity retention ratio of the nonaqueous electrolyte energy storage device after a charge-discharge cycle can be further increased.

### Item 8.

In the nonaqueous electrolyte energy storage device described in the item 6 or 7, the positive electrode potential at the end-of-charge voltage during normal usage may be less than 4.5 V vs. Li/Li⁺.

According to the nonaqueous electrolyte energy storage device described in the item 8, the capacity retention ratio after a charge-discharge cycle of the nonaqueous electrolyte energy storage device can be further increased.

### Item 9.

An energy storage apparatus according to an embodiment of the present invention includes two or more nonaqueous electrolyte energy storage devices, and one or more nonaqueous electrolyte energy storage devices described in any one of items 6 to 8.

According to the energy storage apparatus described in the item 9, an initial discharge capacity per volume of the energy storage apparatus can be increased, and a capacity retention ratio after a charge-discharge cycle can be increased.

First, outlines of a positive electrode for nonaqueous electrolyte energy storage device, a nonaqueous electrolyte energy storage device, and an energy storage apparatus disclosed by the present specification will be described.

A positive electrode for a nonaqueous electrolyte energy storage device according to one aspect of the present invention includes a first positive active material and a second positive active material having different constituent element compositions from each other, the first positive active material is at least one of primary particles that are not substantially aggregated and secondary particles that are aggregated primary particles and have a ratio of an average particle size to an average primary particle size of 5 or less, an average particle size of the first positive active material is ½ or less of an average particle size of the second positive active material, and the second positive active material is a lithium transition metal composite oxide in which a content of a lithium element with respect to a transition metal element is more than 1.0 in terms of a molar ratio.

The positive electrode for a nonaqueous electrolyte energy storage device according to one aspect of the present invention can increase an initial discharge capacity per volume of the nonaqueous electrolyte energy storage device and increase a capacity retention ratio after a charge-discharge cycle. Although the reason why such an effect occurs is not clear, the following reason is presumed. In the positive electrode, as the first positive active material, at least one of primary particles that are not substantially aggregated and secondary particles that are primary particles aggregated and have a ratio of an average particle size (average secondary particle size) to an average primary particle size of 5 or less is used (hereinafter, the “primary particles that are not substantially aggregated, and secondary particles in which the primary particles are aggregated, the secondary particles having a ratio of an average particle size to an average primary particle size of 5 or less” are also collectively referred to as a “single-particle-based particle”). Such single-particle-based particles are less likely to cause cracks or the like due to repeated charge-discharge, and thus capable of increasing the capacity retention ratio of the nonaqueous electrolyte energy storage device after a charge-discharge cycle. Further, in the positive electrode, since the lithium transition metal composite oxide in which the content of the lithium element with respect to the transition metal element is more than 1.0 in terms of a molar ratio is used as the second positive active material, the initial discharge capacity per volume of the nonaqueous electrolyte energy storage device can be increased, and the capacity retention ratio after a charge-discharge cycle can be increased. Furthermore, in the positive electrode, since the average particle size of the first positive active material is ½ or less of the average particle size of the second positive active material, the particles of the first positive active material fill gaps between the particles of the second positive active material, and the filling rate (bulk density) of the positive active material layer is increased. As a result, the initial discharge capacity per volume of the nonaqueous electrolyte energy storage device can be increased.

“The primary particles that are not substantially aggregated” refer to a plurality of primary particles that are present independently without being aggregated, or a primary particle and another primary particle that are not generally directly bound to each other, when the primary particles are observed with a scanning electron microscope (SEM). The primary particles are particles in which no grain boundary is observed in appearance in the observation with the SEM.

The “average primary particle size” of the positive active material is the average value of respective particle sizes of arbitrary fifty primary particles constituting the positive active material observed with the SEM. The particle sizes of the primary particles are determined as follows. The shortest diameter passing through the center of the minimum circumscribed circle of the primary particle is defined as a minor axis, and the diameter passing through the center and orthogonal to the minor axis is defined as a major axis. The average value of the major axis and the minor axis is defined as the particle size of the primary particle. When there are two or more shortest diameters, a shortest diameter with the longest orthogonal diameter is defined as a minor axis.

The “average particle size” of the positive active material means a value at which a volume-based integrated distribution calculated in accordance with JIS-Z-8819-2 (2001) is 50% (D50: median size) based on a particle size distribution measured by a laser diffraction/scattering method for a diluted solution obtained by diluting the positive active material with a solvent in accordance with JIS-Z-8815 (2013). In addition, it has been confirmed that the average particle size based on the measurement mentioned above is almost equal to the average secondary particle size that is the average value of particle sizes of respective secondary particles of the positive active material measured by extracting fifty particles excluding extremely large particles and extremely small particles from the SEM image of the positive active material. The particle sizes of respective secondary particles of the positive active material, based on the measurement from the SEM image, are determined as follows. The SEM image of the positive active material is acquired according to the case of determining the “average primary particle size” mentioned above. The shortest diameter passing through the center of the minimum circumscribed circle of each secondary particle of the positive active material is defined as a minor axis, and the diameter passing through the center and orthogonal to the minor axis is defined as a major axis. The average value of the major axis and the minor axis is defined as the particle size of each secondary particle of the positive active material. When there are two or more shortest diameters, a shortest diameter with the longest orthogonal diameter is defined as a minor axis. The positive active material for measuring the average primary particle size and the average particle size is a positive active material in a fully discharged state by a method described later.

The constituent element composition of the positive active material refers to a constituent element composition when the positive active material is brought into a fully discharged state by the following method. First, the nonaqueous electrolyte energy storage device is subjected to constant current charge with a current of 0.05 C until the voltage becomes an end-of-charge voltage during normal usage, so that the energy storage device is brought to a fully charged state. After a 30-minute pause, the energy storage device is subjected to constant current discharge with a current of 0.05 C to the lower limit voltage during normal usage. The energy storage device is disassembled to take out the positive electrode, and a half cell with a metal lithium electrode as a counter electrode is assembled, and subjected to constant current discharge at a current of 10 mA per 1 g of the positive active material until the positive electrode potential reaches 2.0 V vs. Li/Li⁺, thereby adjusting the positive electrode to the fully discharged state. The battery is disassembled again to take out the positive electrode. A nonaqueous electrolyte attached onto the taken out positive electrode is sufficiently washed with dimethyl carbonate and is dried at room temperature all day and night, and then the positive active material is collected. The collected positive active material is subjected to measurement. Operations from disassembly of the nonaqueous electrolyte energy storage device to collection of the positive active material are performed in an argon atmosphere having a dew point of −60° C. or lower.

Here, the term “during normal usage” means use of the nonaqueous electrolyte energy storage device while employing charge-discharge conditions recommended or specified in the nonaqueous electrolyte energy storage device, and when a charger for the nonaqueous electrolyte energy storage device is prepared, this term means use of the nonaqueous electrolyte energy storage device by applying the charger.

In addition, the phrase “having different constituent element compositions” includes not only a case where the types of constituent elements are different, but also a case where the types of constituent elements are the same and the proportions of constituent elements are different.

The first positive active material is preferably a lithium transition metal composite oxide containing a nickel element. When the first positive active material is such a compound, the initial discharge capacity per volume of the nonaqueous electrolyte energy storage device can be further increased.

The content of the nickel element with respect to the transition metal element in the first positive active material is preferably 0.4 or more and 0.9 or less in terms of a molar ratio. As described above, when the first positive active material is a lithium transition metal composite oxide having a relatively large content of the nickel element, the initial discharge capacity per volume of the nonaqueous electrolyte energy storage device can be further increased.

It is preferable that the second positive active material contains a nickel element and a manganese element as the transition metal element, and the content of the manganese element with respect to the transition metal elements is 0.4 or more and 0.8 or less in terms of a molar ratio. As described above, when the second positive active material is a lithium transition metal composite oxide having such an element composition, the initial discharge capacity per volume of the nonaqueous electrolyte energy storage device can be further increased, and the capacity retention ratio after a charge-discharge cycle can be further increased.

The first positive active material preferably has an average particle size of 3 μm or more and 5 μm or less, and the second positive active material has an average particle size of 10 μm or more and 15 μm or less. When each average particle size of the first positive active material and the second positive active material is within the above range, the filling rate of the positive active material layer is further increased, and as a result, the initial discharge capacity per volume of the nonaqueous electrolyte energy storage device can be increased.

A nonaqueous electrolyte energy storage device according to another aspect of the present invention includes the positive electrode according to the one aspect of the present invention. Since the nonaqueous electrolyte energy storage device includes the positive electrode according to one aspect of the present invention, the nonaqueous electrolyte energy storage device has a large initial discharge capacity per volume and a high capacity retention ratio after a charge-discharge cycle.

In the nonaqueous electrolyte energy storage device, it is preferable that a diffraction peak is present in a range of 20° or more and 220 or less in an X-ray diffraction diagram of the positive electrode using a CuKα ray. In such a case, the capacity retention ratio after a charge-discharge cycle in the nonaqueous electrolyte energy storage device is further increased. Although the reason why such an effect occurs is not clear, the following reason is presumed. The positive electrode provided in the nonaqueous electrolyte energy storage device contains, as the second positive active material, a lithium transition metal composite oxide (lithium-excess-type active material) in which the content of the lithium element with respect to the transition metal element is more than 1.0 in terms of a molar ratio. In the X-ray diffraction diagram of the synthesized lithium-excess-type active material before charge-discharge using a CuKα ray, there is a diffraction peak generally appearing in a monoclinic crystal of Li[Li_{1/3}Mn_{2/3}]O₂ type in the range of 20° or more and 220 or less. In the nonaqueous electrolyte energy storage device using the lithium-excess-type active material, in order to activate the lithium-excess-type active material, the initial charge-discharge may be performed until the positive electrode potential reaches 4.5 V vs. Li/Li⁺ or more as described above (hereinafter, “the fact that the lithium-excess-type active material is activated by charge at which the positive electrode potential reaches 4.5 V vs. Li/Li⁺ or more” is also referred to as high potential formation). When the high potential formation is performed, the diffraction peak in the range of 20° or more and 22° or less disappears due to a change in symmetry of the crystal accompanying lithium extraction in the crystal. That is, the presence of a diffraction peak in the range of 20° or more and 22° or less in an X-ray diffraction diagram of the positive electrode using a CuKα ray means that high potential formation is not performed. Here, the inventors have found that when the lithium-excess-type active material is subjected to high potential formation, the discharge capacity increases, but the capacity retention ratio after a charge-discharge cycle tends to decrease. In other words, the nonaqueous electrolyte energy storage device including the lithium-excess-type active material that high potential formation is not performed has a high capacity retention ratio after a charge-discharge cycle. This is presumed to be because when the high potential formation is not performed, the lithium-excess-type active material is gradually activated by repeating charge-discharge during use, and lithium ions extracted from the lithium-excess-type active material during charge-discharge gradually increase (hereinafter, “the fact that the lithium-excess-type active material is gradually activated associated with repeating charge-discharge during use and the like” is also referred to as temporal formation). That is, when a diffraction peak is present in the range of 20° or more and 22° or less in an X-ray diffraction diagram of the positive electrode using a CuKα ray, lithium ions consumed in a charge-discharge cycle are compensated by temporal formation of the lithium-excess-type active material (second positive active material) of the positive electrode, and thus it is presumed that the capacity retention ratio after a charge-discharge cycle is increased.

The X-ray diffraction measurement on the positive electrode is performed on the positive electrode that is brought into a fully discharged state by the above-described method. Specifically, the X-ray diffraction measurement is performed by powder X-ray diffraction measurement using an X-diffraction device (“MiniFlex I” from Rigaku Corporation) under conditions such that a CuKα ray is used as a radiation source, a tube voltage is 30 kV, and a tube current is 15 mA. At this time, the diffracted X-ray passes through a KB filter with a thickness of 30 μm and is detected by a high-speed one-dimensional detector (D/teX Ultra 2). A sampling width is 0.02°, a scanning speed is 5°/min, a divergence slit width is 0.625°, a light receiving slit width is 13 mm (OPEN), and a scattering slit width is 8 mm.

In the nonaqueous electrolyte energy storage device, the positive electrode potential at the end-of-charge voltage during normal usage is preferably less than 4.5 V vs. Li/Li⁺. When the positive electrode potential at the end-of-charge voltage during normal usage is less than 4.5 V vs. Li/Li⁺, the temporal formation gradually proceeds with charge-discharge repeated many times, and thus the capacity retention ratio after a charge-discharge cycle is further enhanced.

An energy storage apparatus according to another aspect of the present invention includes two or more nonaqueous electrolyte energy storage devices, and one or more nonaqueous electrolyte energy storage devices according to another aspect of the present invention.

Since the energy storage apparatus includes the nonaqueous electrolyte energy storage device capable of increasing the initial discharge capacity per volume of the nonaqueous electrolyte energy storage device and increasing the capacity retention ratio after the charge-discharge cycle, the initial discharge capacity per volume of the energy storage apparatus can be increased and the capacity retention ratio after the charge-discharge cycle can be increased.

Hereinafter, a positive electrode for a nonaqueous electrolyte energy storage device, a nonaqueous electrolyte energy storage device, an energy storage apparatus, a method for producing a nonaqueous electrolyte energy storage device according to an embodiment of the present invention, and other embodiments is described in detail. It is to be noted that the names of the respective constituent members (respective constituent elements) for use in the respective embodiments may be different from the names of the respective constituent members (respective constituent elements) for use in the background art.

### <Positive Electrode for Nonaqueous Electrolyte Energy Storage Device>

A positive electrode for a nonaqueous electrolyte energy storage device according to an embodiment of the present invention includes a positive substrate and a positive active material layer disposed on the positive substrate directly or with an intermediate layer interposed therebetween.

The positive substrate has conductivity. Whether the positive substrate has “conductivity” or not is determined with the volume resistivity of 10⁷ Ω·cm measured in accordance with JIS-H-0505 (1975) as a threshold. As the material of the positive substrate, a metal such as aluminum, titanium, tantalum, or stainless steel, or an alloy thereof is used. Among these metals and alloys, aluminum or an aluminum alloy is preferable from the viewpoints of electric potential resistance, high conductivity, and cost. Examples of the positive substrate include a foil, a deposited film, a mesh, and a porous material, and a foil is preferable from the viewpoint of cost. Accordingly, the positive substrate is preferably an aluminum foil or an aluminum alloy foil. Examples of the aluminum or aluminum alloy include A1085, A3003, and AlN30 specified in JIS-H-4000 (2014) or JIS-H-4160 (2006).

The average thickness of the positive substrate is preferably 3 μm or more and 50 μm or less, more preferably 5 μm or more and 40 μm or less, still more preferably 8 μm or more and 30 μm or less, and particularly preferably 10 μm or more and 25 μm or less. When the average thickness of the positive substrate is within the above-described range, it is possible to enhance the energy density and the discharge capacity per volume of the nonaqueous electrolyte energy storage device while increasing the strength of the positive substrate. The term “average thickness” refers to a value obtained by dividing the cutout mass in cutout of a substrate having a predetermined area by the true density and cutout area of the substrate. The “average thickness” of the negative substrate is similarly defined.

The intermediate layer is a layer disposed between the positive substrate and the positive active material layer. The intermediate layer includes a conductive agent such as carbon particles to reduce contact resistance between the positive substrate and the positive active material layer. The configuration of the intermediate layer is not particularly limited, and includes, for example, a binder and a conductive agent.

The positive active material layer includes a positive active material. The positive active material layer contains optional components such as a conductive agent, a binder, a thickener, a filler, or the like as necessary.

The positive active material contains a first positive active material and a second positive active material having different constituent element compositions.

The first positive active material can be appropriately selected from publicly known positive active materials having different constituent element compositions from those of the second positive active material. The first positive active material may be a lithium transition metal composite oxide in which the content of the lithium element with respect to the transition metal element is more than 1.0 in terms of a molar ratio as in the second positive active material as long as the constituent element composition is different from that of the second positive active material. Examples of the first positive active material include lithium transition metal composite oxides that have an α-NaFeO₂-type crystal structure, lithium transition metal composite oxides that have a spinel-type crystal structure, polyanion compounds, chalcogenides, and sulfur. Examples of the lithium transition metal composite oxides that have an α-NaFeO₂-type crystal structure include Li[LiₓNi₍₁₋ₓ₎]O₂ (0≤x<0.5), Li[LiₓNi_{y}Co_{(1-x-y)}]O₂ (0≤x<0.5, 0<y<1, 0<1-x-y), Li[LiₓCo₍₁₋ₓ₎]O₂ (0≤x<0.5), Li[LiₓNi_{y}Mn_{(1-x-y)}]O₂ (0<x<0.5, 0<y<1, 0<1-x-y), Li[LiₓNi_{y}Mn_{β}Co_{(1-x-y-β)}]O₂ (0<x<0.5, 0<y, 0<β, 0.5<y+β<1, 0<1-x-y-β), and Li[LiₓNi_{y}Co_{β}Al_{(1-x-y-β)}]O₂ (0<x<0.5, 0<y, 0<B, 0.5<y+β<1, 0<1-x-y-β). Examples of the lithium transition metal composite oxides that have a spinel-type crystal structure include LiₓMn₂O₄ and LiₓNi_{y}Mn_{(2-y)}O₄. Examples of the polyanion compounds include LiFePO₄, LiMnPO₄, LiNiPO₄, LiCoPO₄, Li₃V₂(PO₄)₃, Li₂MnSiO₄, and Li₂CoPO₄F. Examples of the chalcogenides include a titanium disulfide, a molybdenum disulfide, and a molybdenum dioxide. Some of atoms or polyanions in these materials may be substituted with atoms or anion species composed of other elements.

The first positive active material is preferably a lithium transition metal composite oxide, more preferably a lithium transition metal composite oxide containing a nickel element, still more preferably a lithium transition metal composite oxide containing a nickel element, a cobalt element, and a manganese element, or a lithium transition metal composite oxide containing a nickel element, a cobalt element, and an aluminum element. The lithium transition metal composite oxide preferably has an a-NaFeO₂-type crystal structure. By using such a lithium transition metal composite oxide as the first positive active material, the initial discharge capacity per volume of the nonaqueous electrolyte energy storage device can be further increased.

The content of nickel element with respect to metal elements other than lithium element in the lithium transition metal composite oxide as the first positive active material is preferably 0.3 or more and 0.9 or less, more preferably 0.4 or more and 0.8 or less, still more preferably 0.5 or more and 0.7 or less, and still more preferably 0.5 or more and 0.6 or less in terms of a molar ratio. When the content of the nickel element in the first positive active material is within the above range, the initial discharge capacity per volume of the nonaqueous electrolyte energy storage device can be further increased.

The content of the cobalt element with respect to metal elements other than the lithium element in the lithium transition metal composite oxide as the first positive active material is preferably 0.05 or more and 0.5 or less, more preferably 0.1 or more and 0.4 or less, still more preferably 0.15 or more and 0.3 or less in terms of a molar ratio.

The content of the manganese element with respect to metal elements other than the lithium element in the lithium transition metal composite oxide as the first positive active material may be more preferably 0.05 or more and 0.6 or less, more preferably 0.1 or more and 0.5 or less, still more preferably 0.2 or more and 0.4 or less, and still more preferably less than 0.4 in terms of a molar ratio.

The content of the aluminum element with respect to metal elements other than the lithium element in the lithium transition metal composite oxide as the first positive active material may be more preferably 0.005 or more and 0.2 or less, more preferably 0.010 or more and 0.100 or less, still more preferably 0.015 or more and 0.050 or less, and even more preferably 0.020 or 0.025 or more in terms of a molar ratio. The content of the aluminum element with respect to metal elements other than the lithium element in the lithium transition metal composite oxide as the first positive active material may be more preferably 0.020 or less, 0.010 or less, or 0.005 or less in terms of a molar ratio.

The content of the lithium element with respect to metal elements other than the lithium element in the lithium transition metal composite oxide as the first positive active material is preferably 1.0 or more and 1.6 or less in terms of a molar ratio. The upper limit of the molar ratio may be more preferably 1.4, 1.2, 1.1, or 1.05. The molar ratio may be substantially 1 (for example, 0.95 or more and 1.05 or less).

As the first positive active material, a compound represented by the following formula 1 is preferable.

Li_{1+α}M¹_{1-α}O₂ 1

In the formula 1, M¹ is a metal element containing Ni (excluding Li). The condition of 0≤α<1 is met.

M¹ in the formula 1 preferably contains Ni, Co, and Mn, or contains Ni, Co, and Al, and is more preferably substantially composed of three elements of Ni, Co, and Mn, or substantially composed of three elements of Ni, Co, and Al. However, M¹ may contain other metal elements. The other metal element may be a transition metal element or a typical metal element.

From the viewpoint of the discharge capacity, the capacity retention ratio, and the like, the preferred content (composition ratio) of each constituent element in the compound represented by formula 1 is as follows.

In the formula 1, the lower limit of the molar ratio of Ni to M¹ (Ni/M¹) is preferably 0.3, more preferably 0.4, and still more preferably 0.5. On the other hand, the upper limit of the molar ratio (Ni/M¹) is preferably 0.9, more preferably 0.8, still more preferably 0.7 or 0.6.

In the formula 1, the lower limit of the molar ratio of Co to M¹ (Co/M¹) is preferably 0.05, more preferably 0.1, and still more preferably 0.15. On the other hand, the upper limit of the molar ratio (Co/M¹) is preferably 0.5, more preferably 0.4, and still more preferably 0.3.

In the formula 1, the lower limit of the molar ratio of Mn to M¹ (Mn/M¹) is preferably 0.05, more preferably 0.1, and still more preferably 0.2. On the other hand, the upper limit of the molar ratio (Mn/M¹) may be more preferably 0.6, more preferably 0.5, still more preferably 0.4, and even more preferably less than 0.4.

In the formula 1, the lower limit of the molar ratio of Al to M¹(Al/M¹) may be more preferably 0.005, and more preferably 0.010, 0.015, 0.020, or 0.025. On the other hand, the upper limit of the molar ratio (Al/M¹) may be more preferably 0.200, and more preferably 0.100 or 0.050.

In the formula 1, the upper limit of the molar ratio of Li to M¹ (Li/M¹), that is, (1+α)/(1−α) may be more preferably 1.6, and more preferably 1.4, 1.2, 1.1, or 1.05. The lower limit of the molar ratio (Li/M¹) may be 0.95 or 1.0. The molar ratio (Li/M¹) may be 1. That is, a may be 0.

The first positive active material is single-particle-based particles. The single-particle-based particles are less likely to cause cracks or the like due to repeated charge-discharge, and thus capable of increasing the capacity retention ratio of the nonaqueous electrolyte energy storage device after a charge-discharge cycle. Examples of the single-particle-based particles include primary particles A that are not substantially aggregated (particles that are each a primary particle present alone).

Other examples of the single-particle-based particles include secondary particles B that have primary particles aggregated, with the ratio of the average particle size (average secondary particle size) to the average primary particle size being 5 or less. The ratio of the average particle size to the average primary particle size is preferably 4 or less, more preferably 3 or less, and still more preferably 2 or less. The ratio of the ratio of the average particle size of the secondary particles B to the average primary particle size is equal to or less than the upper limit mentioned above, thereby allowing advantages of the single-particle-based particles to be sufficiently brought, such as the fact that cracks and the like are less likely to be generated. The lower limit of the ratio of the average particle size of the secondary particles B to the average primary particle size may be 1. From the difference between the method for measuring the average primary particle size and the method for measuring the average particle size (secondary particle size), the lower limit of the ratio of the average particle size to the average primary particle size of the secondary particles B may be less than 1, for example, 0.9.

The first positive active material which is a single-particle-based particle may be formed by mixing the primary particles A and the secondary particles B. For example, of the arbitrary fifty particles of the first positive active material observed with the SEM, the number of primary particles A is preferably more than twenty five, more preferably thirty or more, and further preferably forty or more. The first positive active material may be composed substantially of only primary particles A.

The single particle-based particles can be produced by any publicly known method, and a commercially available product may be used for the single-particle-based particles. For example, in the process of producing the first positive active material particles, increasing the firing temperature or prolonging the firing time causes a plurality of primary particles to grow to increase the particle size, thereby allowing single-particle-based particles to be obtained. Alternatively, the single-particle-based particles can be obtained by crushing the secondary particles.

The average particle size of the first positive active material is ½ or less, preferably ⅖ or less, and more preferably ⅓ or less of the average particle size of the second positive active material. As described above, by using the first positive active material having a relatively small particle size with respect to the second positive active material, the filling rate of the positive active material layer is increased, and as a result, the initial discharge capacity per volume of the nonaqueous electrolyte energy storage device can be increased. The lower limit of the average particle size of the first positive active material with respect to the average particle size of the second positive active material may be, for example, 1/10 or ⅕.

The average particle size of the first positive active material is not particularly limited as long as it is ½ or less of the average particle size of the second positive active material, and may be, for example, 1 μm or more and 10 μm or less, preferably 3 μm or more and 5 μm or less, and more preferably 4 μm or less. By setting the average particle size of the first positive active material to be equal to or more than the lower limit mentioned above, the first positive active material is easily manufactured or handled. By setting the average particle size of the first positive active material to be equal to or less than the upper limit mentioned above, the filling rate of the positive active material layer is further increased, and the initial discharge capacity per volume of the nonaqueous electrolyte energy storage device can be further increased.

In order to obtain particles of the first positive active material or the like with a predetermined average particle size, a crusher and a classifier and the like are used. Examples of a crushing method include a method in which a mortar, a ball mill, a sand mill, a vibratory ball mill, a planetary ball mill, a jet mill, a counter jet mill, a whirling airflow type jet mill, or a sieve or the like is used. At the time of crushing, wet-type crushing in coexistence of water or an organic solvent such as hexane can also be used. As a classification method, a sieve or a wind force classifier or the like is used based on the necessity both in dry manner and in wet manner.

The second positive active material is a lithium transition metal composite oxide in which the content of the lithium element with respect to the transition metal element is more than 1.0 in terms of a molar ratio. The lower limit of the content of the lithium element with respect to the transition metal element in the second positive active material is preferably 1.1, and more preferably 1.2 in terms of a molar ratio in some cases. On the other hand, the upper limit of the molar ratio is preferably 1.7, more preferably 1.5, and still more preferably 1.3. Since the second positive active material is a lithium-excess-type active material as described above, the initial discharge capacity per volume of the nonaqueous electrolyte energy storage device can be increased, and the capacity retention ratio after a charge-discharge cycle can be increased.

The second positive active material preferably contains a manganese element, and more preferably contains a nickel element. When the second positive active material is a lithium transition metal composite oxide in which the content of the lithium element with respect to the transition metal element containing such an element is more than 1.0 in terms of a molar ratio, the initial discharge capacity per volume of the nonaqueous electrolyte energy storage device can be further increased, and the capacity retention ratio after a charge-discharge cycle can be further increased. The second positive active material may further contain other elements such as cobalt element.

The content of the manganese element with respect to the transition metal element in the lithium transition metal composite oxide as the second positive active material is preferably 0.2 or more and 0.9 or less, more preferably 0.3 or more and 0.9 or less, still more preferably 0.4 or more and 0.8 or less in terms of a molar ratio. When the content of the manganese element in the second positive active material is within the above range, the capacity retention ratio of the nonaqueous electrolyte energy storage device after a charge-discharge cycle can be further increased.

The content of the nickel element with respect to the transition metal element in the lithium transition metal composite oxide as the second positive active material may be more preferably 0.1 or more and 0.7 or less, more preferably 0.2 or more and 0.6 or less, still more preferably 0.3 or more and 0.5 or less, and even more preferably less than 0.5 in terms of a molar ratio.

The content of the cobalt element with respect to the transition metal element in the lithium transition metal composite oxide as the second positive active material is preferably 0 or more and 0.5 or less, more preferably 0.05 or more and 0.4 or less, still more preferably 0.1 or more and 0.3 or less in terms of a molar ratio.

The second positive active material is preferably a compound represented by the following formula 2.

Li_{1+β}M²_{1-β}O₂ 2

In the formula 2, M² is a metal element containing Mn (excluding Li). 0<β<1.

M² in the formula 2 preferably contains Mn, and more preferably contains Ni and Mn in some cases, and still more preferably contains Ni, Co, and Mn. M² in the formula 2 may be more preferably substantially composed of two elements of Ni and Mn in some cases, and may be particularly preferably composed of three elements of Ni, Co, and Mn. However, M² may contain other metal elements. The other metal element may be a transition metal element or a typical metal element such as an aluminum element.

From the viewpoint of the discharge capacity, the capacity retention ratio, and the like, the preferred content (composition ratio) of each constituent element in the compound represented by formula 2 is as follows.

In the formula 2, the lower limit of the molar ratio of Ni to M² (Ni/M²) is preferably 0.1, more preferably 0.2, and still more preferably 0.3. On the other hand, the upper limit of the molar ratio (Ni/M²) may be more preferably 0.7, more preferably 0.6, still more preferably 0.5, and even more preferably less than 0.5.

In the formula 2, the lower limit of the molar ratio of Co to M² (Co/M²) may be 0, and preferably 0.05 or 0.1. On the other hand, the upper limit of the molar ratio (Co/M²) is preferably 0.5, more preferably 0.4, and still more preferably 0.3.

In the formula 2, the lower limit of the molar ratio of Mn to M² (Mn/M²) is preferably 0.2, more preferably 0.3, and still more preferably 0.4. On the other hand, the upper limit of the molar ratio (Mn/M²) is preferably 0.9, and more preferably 0.8.

In the formula 2, the upper limit of the molar ratio of Li to M² (Li/M²), that is, (1+β)/(1−β) is preferably 1.7, more preferably 1.5, and still more preferably 1.3. The lower limit of the molar ratio of Li to M² (Li/M²) may be more preferably 1.1, and more preferably 1.2. The B in the formula 2 is preferably 0.03 or more and 0.3 or less, and more preferably 0.05 or more and 0.2 or less.

The second positive active material is usually secondary particles (particles other than single-particle-based particles). The second positive active material may be single-particle-based particles. The average particle size of the second positive active material is preferably 5 μm or more and 20 μm or less, and more preferably 10 μm or more and 15 μm or less. By setting the average particle size of the second positive active material to be equal to or more than the lower limit mentioned above, the second positive active material is easily manufactured or handled. By setting the average particle size of the second positive active material to be equal to or less than the upper limit mentioned above, the electron conductivity of the positive active material layer is improved.

As a content ratio (mixing ratio) between the first positive active material and the second positive active material, the first positive active material: the second positive active material is preferably 10:90 to 90:10, more preferably 20:80 to 80:20, still more preferably 30:70 to 70:30, and still more preferably 40:60 to 60:40 on a mass basis. By setting the content ratio of the first positive active material and the second positive active material within the above range, the filling rate of the positive active material layer is further increased, so that the initial discharge capacity per volume of the nonaqueous electrolyte energy storage device can be further increased.

The positive active material may contain other positive active materials other than the first positive active material and the second positive active material. However, the total content of the first positive active material and the second positive active material with respect to all the positive active materials contained in the positive active material layer is preferably 90% by mass or more, more preferably 99% by mass or more, and still more preferably 100% by mass. The positive active material is also preferably composed of only the first positive active material and the second positive active material. When the positive active material is composed of only the first positive active material and the second positive active material as described above, the initial discharge capacity per volume of the nonaqueous electrolyte energy storage device can be further increased, and the capacity retention ratio after a charge-discharge cycle can be further increased.

The content of the positive active material in the positive active material layer is preferably 50% by mass or more and 99% by mass or less, more preferably 70% by mass or more and 98% by mass or less, and still more preferably 80% by mass or more and 95% by mass or less. The total content of the first positive active material and the second positive active material in the positive active material layer is preferably 50% by mass or more and 99% by mass or less, more preferably 70% by mass or more and 98% by mass or less, still more preferably 80% by mass or more and 95% by mass or less. When the content of the positive active material or the total content of the first positive active material and the second positive active material is within the above range, both high energy density and manufacturability of the positive active material layer can be achieved.

The conductive agent is not particularly limited as long as the agent is a material with conductivity. Examples of such a conductive agent include carbonaceous materials, metals, and conductive ceramics. Examples of the carbonaceous materials include graphite, non-graphitic carbon, and graphene-based carbon. Examples of the non-graphitic carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the form of the conductive agent include a powdery form and a fibrous form. As the conductive agent, one of these materials may be used alone, or two or more thereof may be used in mixture. In addition, these materials may be used in combination. For example, a composite material of carbon black and CNT may be used. Among these materials, carbon black is preferable from the viewpoints of electron conductivity and coatability, and in particular, acetylene black is preferable.

The content of the conductive agent in the positive active material layer is preferably 1% by mass or more and 10% by mass or less, more preferably 3% by mass or more and 9% by mass or less. By setting the content of the conductive agent to the above range, the energy density of the nonaqueous electrolyte energy storage device can be enhanced.

Examples of the binder mentioned above include: thermoplastic resins such as fluororesins (e.g., polytetrafluoroethylene (PTFE), polyvinylidene fluoride (PVDF)), polyethylene, polypropylene, polyacryl, and polyimide; elastomers such as an ethylene-propylene-diene rubber (EPDM), sulfonated EPDM, a styrene butadiene rubber (SBR), and a fluororubber; and polysaccharide polymers.

The content of the binder in the positive active material layer is preferably 1% by mass or more and 10% by mass or less, more preferably 3% by mass or more and 9% by mass or less. By setting the binder content to the above range, the positive active material can be stably held.

Examples of the thickener include polysaccharide polymers such as a carboxymethylcellulose (CMC) and a methylcellulose. When the thickener mentioned above has a functional group that is reactive with lithium and the like, the functional group may be deactivated by methylation or the like in advance.

When the positive active material layer contains a thickener, the content of the thickener in the positive active material layer can be, for example, 0.1% by mass or more and 5% by mass or less. The content of the thickener in the positive active material layer may be 1% by mass or less, and it may be preferable that no thickener is contained in the positive active material layer.

The filler is not particularly limited. Examples of the filler include polyolefins such as polypropylene and polyethylene, inorganic oxides such as silicon dioxide, alumina, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, and barium sulfate, nitrides such as aluminum nitride and silicon nitride, and substances derived from mineral resources, such as talc, montmorillonite, boehmite, zeolite, apatite, kaolin, mullite, spinel, olivine, sericite, bentonite and mica, or artificial products thereof.

When the positive active material layer contains a filler, the content of the filler in the positive active material layer can be, for example, 0.1% by mass or more and 5% by mass or less. The content of the filler in the positive active material layer may be 1% by mass or less, and it may be preferable that no filler is contained in the positive active material layer.

The positive active material layer may contain a typical nonmetal element such as B, N, P, F, Cl, Br, and I, a typical metal element such as Li, Na, Mg, Al, K, Ca, Zn, Ga, Ge, Sn, Sr, and Ba, or a transition metal element such as Sc, Ti, V, Cr, Mn, Fe, Co, Ni, Cu, Mo, Zr, Nb, and W as a component other than the positive active material, the conductive agent, the binder, the thickener, and the filler.

The positive electrode according to an embodiment of the present invention is used for a nonaqueous electrolyte energy storage device. The nonaqueous electrolyte energy storage device is not particularly limited, but is usually a lithium ion energy storage device. The nonaqueous electrolyte energy storage device is preferably a nonaqueous electrolyte secondary battery, and more preferably a lithium ion secondary battery.

### <Nonaqueous Electrolyte Energy Storage Device>

A nonaqueous electrolyte energy storage device according to an embodiment of the present invention (hereinafter, also referred to simply as an “energy storage device”) includes: an electrode assembly including a positive electrode, a negative electrode, and a separator; a nonaqueous electrolyte; and a case that houses the electrode assembly and the nonaqueous electrolyte. The electrode assembly is usually a stacked type in which a plurality of positive electrodes and a plurality of negative electrodes are stacked with a separator interposed therebetween, or a wound type in which a positive electrode and a negative electrode are wound in a state of being stacked with a separator interposed therebetween. The nonaqueous electrolyte is present with the positive electrode, negative electrode, and separator impregnated with the electrolyte. A nonaqueous electrolyte secondary battery (hereinafter, also simply referred to as a “secondary battery”) will be described as an example of the nonaqueous electrolyte energy storage device.

### (Positive Electrode)

The positive electrode provided in the nonaqueous electrolyte energy storage device is the positive electrode according to one embodiment of the present invention described above. It is preferable that a diffraction peak is present in a range of 20° or more and 22° or less in an X-ray diffraction diagram using a CuKα ray of a positive electrode provided in the nonaqueous electrolyte energy storage device. The presence of the diffraction peak means that high potential formation is not performed after the nonaqueous electrolyte energy storage device is assembled, and such a nonaqueous electrolyte energy storage device has a higher capacity retention ratio after a charge-discharge cycle.

### (Negative Electrode)

The negative electrode has a negative substrate and a negative active material layer disposed directly on the negative substrate or over the negative substrate with an intermediate layer interposed therebetween. The configuration of the intermediate layer is not particularly limited, and can be selected from the configurations exemplified for the positive electrode, for example.

The negative substrate has conductivity. As the material of the negative substrate, a metal such as copper, nickel, stainless steel, nickel-plated steel, or aluminum, an alloy thereof, a carbonaceous material, or the like is used. Among these metals and alloys, the copper or copper alloy is preferable. Examples of the negative substrate include a foil, a deposited film, a mesh, and a porous material, and a foil is preferable from the viewpoint of cost. Accordingly, the negative substrate is preferably a copper foil or a copper alloy foil. Examples of the copper foil include a rolled copper foil and an electrolytic copper foil.

The average thickness of the negative substrate is preferably 2 μm or more and 35 μm or less, more preferably 3 μm or more and 30 μm or less, still more preferably 4 μm or more and 25 μm or less, and particularly preferably 5 μm or more and 20 μm or less. When the average thickness of the negative substrate is within the above-described range, it is possible to enhance the energy density and the discharge capacity per volume of the nonaqueous electrolyte energy storage device while increasing the strength of the negative substrate.

The negative active material layer includes a negative active material. The negative active material layer contains optional components such as a conductive agent, a binder, a thickener, and a filler, if necessary. The optional components such as a conductive agent, a binder, a thickener, and a filler can be selected from the materials exemplified for the positive electrode. The contents of these optional components in the negative active material layer can be within the ranges described as the contents of the components in the positive active material layer.

The negative active material layer may contain a typical nonmetal element such as B, N, P, F, Cl, Br, and I, a typical metal element such as Li, Na, Mg, Al, K, Ca, Zn, Ga, Ge, Sn, Sr, and Ba, or a transition metal element such as Sc, Ti, V, Cr, Mn, Fe, Co, Ni, Cu, Mo, Zr, Ta, Hf, Nb, and W as a component other than the negative active material, the conductive agent, the binder, the thickener, and the filler.

The negative active material can be appropriately selected from publicly known negative active materials. As the negative active material for a lithium ion secondary battery, a material capable of absorbing and releasing lithium ions is usually used. Examples of the negative active material include metallic lithium; metals or metalloids such as Si and Sn; metal oxides or metalloid oxides such as a Si oxide, a Ti oxide, and a Sn oxide; titanium-containing oxides such as Li₄Ti₅O₁₂, LiTiO₂, and TiNb₂O₇; a polyphosphoric acid compound; silicon carbide; and carbon materials such as graphite and non-graphitic carbon (easily graphitizable carbon or hardly graphitizable carbon). Among these materials, the graphite and the non-graphitic carbon are preferable. In the negative active material layer, one of these materials may be used alone, or two or more thereof may be used in mixture.

The term “graphite” refers to a carbon material in which an average grid spacing (d₀₀₂) of a (002) plane determined by X-ray diffraction before charge-discharge or in a discharged state is 0.33 nm or more and less than 0.34 nm. Examples of the graphite include natural graphite and artificial graphite. Artificial graphite is preferable from the viewpoint that a material having stable physical properties can be procured.

The term “non-graphitic carbon” refers to a carbon material in which the average grid spacing (d₀₀₂) of a (002) plane determined by X-ray diffraction before charge-discharge or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol derived material.

In this regard, the “discharged state” in the carbon material means a state discharged such that lithium ions that can be occluded and released in association with charge-discharge are sufficiently released from the carbon material that is the negative active material. For example, the “discharged state” refers to a state where the open circuit voltage is 0.7 V or higher in a half cell that has, for use as a working electrode, a negative electrode containing a carbon material as a negative active material, and has metal lithium for use as a counter electrode.

The term “hardly graphitizable carbon” refers to a carbon material in which the d₀₀₂ is 0.36 nm or more and 0.42 nm or less.

The term “easily graphitizable carbon” refers to a carbon material in which the d₀₀₂ is 0.34 nm or more and less than 0.36 nm.

The negative active material is typically particles (powder). The average particle size of the negative active material can be, for example, 1 nm or more and 100 μm or less. When the negative active material is a carbon material, a titanium-containing oxide, or a polyphosphoric acid compound, the average particle size thereof may be 1 μm or more and 100 μm or less. When the negative active material is Si, Sn, an oxide of Si, an oxide of Sn, or the like, the average particle size thereof may be 1 nm or more and 1 μm or less. By setting the average particle size of the negative active material to be equal to or greater than the above lower limit, the negative active material is easily produced or handled. By setting the average particle size of the negative active material to be equal to or less than the upper limit, the electron conductivity of the negative active material layer is improved. A crusher, a classifier, or the like is used in order to obtain a powder with a predetermined particle size. The crushing method and classification method can be selected from, for example, the methods exemplified for the positive electrode. When the negative active material is a metal such as metallic lithium, the negative active material layer may have the form of a foil.

The content of the negative active material in the negative active material layer is preferably 60% by mass or more and 99% by mass or less, more preferably 90% by mass or more and 98% by mass or less. The content of the negative active material falls within the range mentioned above, thereby allowing a balance to be achieved between the increased energy density and productivity of the negative active material layer.

### (Separator)

The separator can be appropriately selected from publicly known separators. As the separator, for example, a separator composed of only a substrate layer, a separator in which a heat resistant layer containing heat resistant particles and a binder is formed on one surface or both surfaces of the substrate layer, or the like can be used. Examples of the form of the substrate layer of the separator include a woven fabric, a nonwoven fabric, and a porous resin film. Among these forms, a porous resin film is preferable from the viewpoint of strength, and a nonwoven fabric is preferable from the viewpoint of liquid retaining properties of the nonaqueous electrolyte. As the material for the substrate layer of the separator, for example, a polyolefin such as polyethylene or polypropylene is preferable from the viewpoint of shutdown function, and polyimide, aramid or the like is preferable from the viewpoint of resistance to oxidative decomposition. As the substrate layer of the separator, a material obtained by combining these resins may be used.

The heat resistant particles included in the heat resistant layer preferably have a mass loss of 5% or less in the case of temperature increase from room temperature to 500° C. under the air atmosphere of 1 atm, and more preferably have a mass loss of 5% or less in the case of temperature increase from room temperature to 800° C. Examples of materials that have a mass loss equal to or less than a predetermined value include inorganic compounds. Examples of the inorganic compound include oxides such as iron oxide, silicon oxide, aluminum oxide, titanium dioxide, zirconium oxide, calcium oxide, strontium oxide, barium oxide, magnesium oxide and aluminosilicate; nitrides such as aluminum nitride and silicon nitride; carbonates such as calcium carbonate; sulfates such as barium sulfate; hardly soluble ionic crystals such as calcium fluoride, barium fluoride, barium titanate; covalently bonded crystals such as silicon and diamond; and substances derived from mineral resources, such as talc, montmorillonite, boehmite, zeolite, apatite, kaolin, mullite, spinel, olivine, sericite, bentonite, and mica, and artificial products thereof. As the inorganic compounds, simple substances or complexes of these substances may be used alone, or two or more thereof may be used in mixture. Among these inorganic compounds, the silicon oxide, aluminum oxide, or aluminosilicate is preferable from the viewpoint of the safety of the energy storage device.

The porosity of the separator is preferably 80% by volume or less from the viewpoint of strength, and is preferably 20% by volume or more from the viewpoint of discharge performance. The term “porosity” herein is a volume-based value, and means a value measured with a mercury porosimeter.

As the separator, a polymer gel composed of a polymer and a nonaqueous electrolyte may be used. Examples of the polymer include a polyacrylonitrile, a polyethylene oxide, a polypropylene oxide, a polymethyl methacrylate, a polyvinyl acetate, a polyvinylpyrrolidone, and a polyvinylidene fluoride. The use of the polymer gel has the effect of suppressing liquid leakage. As the separator, the polymer gel may be used in combination with a porous resin film, a nonwoven fabric, or the like as described above.

### (Nonaqueous Electrolyte)

The nonaqueous electrolyte can be appropriately selected from publicly known nonaqueous electrolytes. For the nonaqueous electrolyte, a nonaqueous electrolyte solution may be used. The nonaqueous electrolyte solution includes a nonaqueous solvent and an electrolyte salt dissolved in the nonaqueous solvent.

The nonaqueous solvent can be appropriately selected from publicly known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, solvents in which some of the hydrogen atoms included in these compounds are substituted with halogen may be used. For example, by using a compound in which some of hydrogen atoms contained in these compounds are substituted with fluorine atoms (fluorinated cyclic carbonate, fluorinated chain carbonate, etc.), it can be sufficiently used even under use conditions where the positive electrode potential reaches a high potential.

Examples of the cyclic carbonates include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among them, EC and FEC are preferable.

Examples of the chain carbonates include diethyl carbonate (DEC), dimethyl carbonate (DMC), ethyl methyl carbonate (EMC), diphenyl carbonate, trifluoroethyl methyl carbonate, and bis(trifluoroethyl)carbonate. Among these, DMC and EMC are preferable.

As the nonaqueous solvent, it is preferable to use the cyclic carbonate or the chain carbonate, and it is more preferable to use the cyclic carbonate and the chain carbonate in combination. The use of the cyclic carbonate allows the promoted dissociation of the electrolyte salt to improve the ionic conductivity of the nonaqueous electrolyte solution. The use of the chain carbonate allows the viscosity of the nonaqueous electrolyte solution to be kept low. When the cyclic carbonate and the chain carbonate are used in combination, the volume ratio of the cyclic carbonate to the chain carbonate (cyclic carbonate:chain carbonate) preferably falls within the range from 5:95 to 50:50, for example.

The electrolyte salt can be appropriately selected from publicly known electrolyte salts. The electrolyte salt is preferably a lithium salt.

Examples of the lithium salt include inorganic lithium salts such as LiPF₆, LiPO₂F₂, LiBF₄, LiClO₄, and LiN(SO₂F)₂, lithium oxalates such as lithium bis(oxalate)borate (LiBOB), lithium difluorooxalatoborate (LiFOB), and lithium bis(oxalate)difluorophosphate (LiFOP), and lithium salts having a halogenated hydrocarbon group, such as LiSO₃CF₃, LiN(SO₂CF₃)₂, LiN(SO₂C₂F₅)₂, LiN(SO₂CF₃)(SO₂C₄F), LiC(SO₂CF₃)₃, and LiC(SO₂C₂F₅)₃. Among these salts, the inorganic lithium salts are preferable, and LiPF₆ is more preferable.

The content of the electrolyte salt in the nonaqueous electrolyte solution is, at 20° C. under 1 atm, preferably 0.1 mol/dm³ or more and 2.5 mol/dm³ or less, more preferably 0.3 mol/dm³ or more and 2.0 mol/dm³ or less, still more preferably 0.5 mol/dm³ or more and 1.7 mol/dm³ or less, particularly preferably 0.7 mol/dm³ or more and 1.5 mol/dm³ or less. The content of the electrolyte salt falls within the range mentioned above, thereby allowing the ionic conductivity of the nonaqueous electrolyte solution to be increased.

The nonaqueous electrolyte solution may include an additive, besides the nonaqueous solvent and the electrolyte salt. Examples of the additive include aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; vinylene carbonate, methylvinylene carbonate, ethylvinylene carbonate, succinic anhydride, glutaric anhydride, maleic anhydride, citraconic anhydride, glutaconic anhydride, itaconic anhydride, cyclohexanedicarboxylic anhydride; ethylene sulfite, propylene sulfite, dimethyl sulfite, methyl methanesulfonate, busulfan, methyl toluenesulfonate, dimethyl sulfate, ethylene sulfate, sulfolane, dimethyl sulfone, diethyl sulfone, dimethylsulfoxide, diethyl sulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, 1,3-propene sultone, 1,3-propane sultone, 1,4-butane sultone, 1,4-butene sultone, perfluorooctane, tristrimethylsilyl borate, tristrimethylsilyl phosphate, tetrakistrimethylsilyl titanate, lithium monofluorophosphate, and lithium difluorophosphate. One of these additives may be used alone, or two or more thereof may be used in mixture.

The content of the additive contained in the nonaqueous electrolyte solution is preferably 0.01% by mass or more and 10% by mass or less, more preferably 0.1% by mass or more and 7% by mass or less, still more preferably 0.2% by mass or more and 5% by mass or less, particularly preferably 0.3% by mass or more and 3% by mass or less, with respect to a total mass of the nonaqueous electrolyte solution. The content of the additive falls within the range mentioned, thereby making it possible to improve capacity retention performance or cycle performance after high-temperature storage, and to further improve safety.

For the nonaqueous electrolyte, a solid electrolyte may be used, or a nonaqueous electrolyte solution and a solid electrolyte may be used in combination.

The solid electrolyte can be selected from arbitrary materials with ionic conductivity, which are solid at normal temperature (for example, 15° C. to 25° C.), such as lithium, sodium, and calcium. Examples of the solid electrolyte include sulfide solid electrolytes, oxide solid electrolytes, oxynitride solid electrolytes, and polymer solid electrolytes.

Examples of the sulfide solid electrolyte include Li₂S—P₂S₅, LiI—Li₂S—P₂S₅, and Li₁₀Ge—P₂S₁₂ in the case of a lithium ion secondary battery.

(Positive electrode potential at end-of-charge voltage during normal usage) In the nonaqueous electrolyte energy storage device, the positive electrode potential (positive electrode achieved potential) at the end-of-charge voltage during normal usage is not particularly limited, and may be more preferably less than 4.5 V vs. Li/Li⁺, more preferably less than 4.45 V vs. Li/Li⁺, and still more preferably less than 4.4 V vs. Li/Li⁺. By setting the positive electrode potential at the end-of-charge voltage during normal usage to be less than the above upper limit, the temporal formation proceeds gradually, so that the capacity retention ratio after a charge-discharge cycle can be further increased.

In the nonaqueous electrolyte energy storage device, the positive electrode potential at the end-of-charge voltage during normal usage may be preferably 4.25 V vs. Li/Li⁺ or more, more preferably 4.3 V vs. Li/Li⁺ or more, still more preferably 4.35 V vs. Li/Li⁺ or more. By setting the positive electrode potential at the end-of-charge voltage during normal usage to be equal to or more than the lower limit mentioned above, the initial discharge capacity per volume of the nonaqueous electrolyte energy storage device can be further increased. In addition, by setting the positive electrode potential at the end-of-charge voltage during normal usage to be equal to or more than the lower limit mentioned above, the temporal formation proceeds sufficiently with the charge-discharge cycle, so that the capacity retention ratio after the charge-discharge cycle can be increased.

The method for using the nonaqueous electrolyte energy storage device according to one embodiment of the present invention may include, for example, charging the nonaqueous electrolyte energy storage device in a range where a positive electrode potential (positive electrode arrival potential) is less than 4.5 V vs. Li/Li⁺. The upper limit of the positive electrode potential (positive electrode achieved potential) in this charge is more preferably less than 4.45 V vs. Li/Li⁺, and still more preferably less than 4.4 V vs. Li/Li⁺. The lower limit of the positive electrode potential (positive electrode achieved potential) in this charge may be more preferably more than 4.25 V vs. Li/Li⁺, more preferably 4.3 V vs. Li/Li⁺, and still more preferably 4.35 V vs. Li/Li⁺.

The shape of the nonaqueous electrolyte energy storage device according to the present embodiment is not particularly limited, and examples thereof include cylindrical batteries, prismatic batteries, flat batteries, coin batteries and button batteries.

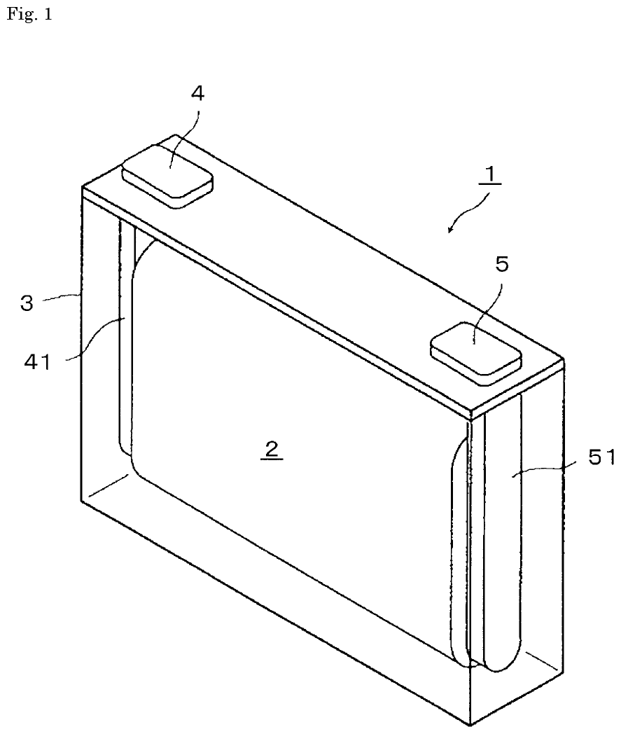

FIG. 1 illustrates a nonaqueous electrolyte energy storage device 1 as an example of prismatic batteries. FIG. 1 is a view illustrating the inside of a case in a perspective manner. An electrode assembly 2 including a positive electrode and a negative electrode wound with a separator interposed therebetween is housed in a prismatic case 3. The positive electrode is electrically connected to a positive electrode terminal 4 via a positive electrode lead 41. The negative electrode is electrically connected to a negative electrode terminal 5 via a negative electrode lead 51.

### <Energy Storage Apparatus>

The nonaqueous electrolyte energy storage device according to the present embodiment can be mounted as an energy storage unit (battery module) configured by assembling a plurality of nonaqueous electrolyte energy storage devices on a power source for automobiles such as electric vehicles (EV), hybrid vehicles (HEV), and plug-in hybrid vehicles (PHEV), a power source for electronic devices such as personal computers and communication terminals, or a power source for power storage, or the like. In this case, the technique of the present invention may be applied to at least one nonaqueous electrolyte energy storage device included in the energy storage unit.

The energy storage apparatus according to an embodiment of the present invention includes two or more nonaqueous electrolyte energy storage devices and one or more nonaqueous electrolyte energy storage devices according to an embodiment of the present invention (hereinafter referred to as “second embodiment”). The technique according to an embodiment of the present invention may be applied to at least one nonaqueous electrolyte energy storage device included in the energy storage apparatus according to the second embodiment, one nonaqueous electrolyte energy storage device according to an embodiment of the present invention may be provided, and one or more nonaqueous electrolyte energy storage devices not according to an embodiment of the present invention may be provided, or two or more nonaqueous electrolyte energy storage devices according to an embodiment of the present invention may be provided.

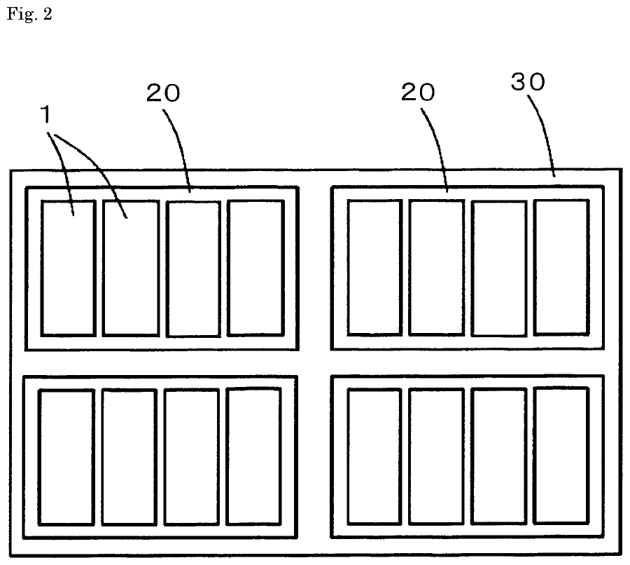

FIG. 2 illustrates an example of an energy storage apparatus 30 according to the second embodiment, formed by further assembling energy storage units 20 in each of which two or more electrically connected nonaqueous electrolyte energy storage devices 1 are assembled. The energy storage apparatus 30 may include a busbar (not illustrated) for electrically connecting two or more nonaqueous electrolyte energy storage devices 1 and a busbar (not illustrated) for electrically connecting two or more energy storage units 20. The energy storage unit 20 or the energy storage apparatus 30 may include a state monitor (not illustrated) that monitors the state of one or more nonaqueous electrolyte energy storage devices 1.

### <Method for Manufacturing Nonaqueous Electrolyte Energy Storage Device>

A method for manufacturing the nonaqueous electrolyte energy storage device of the present embodiment can be appropriately selected from publicly known methods. The manufacturing method includes, for example, preparing an electrode assembly, preparing a nonaqueous electrolyte, and housing the electrode assembly and the nonaqueous electrolyte in a case. The preparation of the electrode assembly includes: preparing a positive electrode; preparing a negative electrode; and forming the electrode assembly by stacking or winding the positive electrode and the negative electrode with a separator interposed therebetween.

The positive electrode can be prepared, for example, by applying a positive composite paste to a positive substrate directly or via an intermediate layer, followed by drying. The positive composite paste contains components constituting a positive active material layer such as a positive active material, and a dispersion medium. The applied positive composite paste may be dried and then pressed or the like.

The negative electrode can be prepared, for example, by applying a negative composite paste to a negative substrate directly or via an intermediate layer, followed by drying. The negative composite paste contains components constituting the negative active material layer, such as a negative active material, and a dispersion medium. The applied negative composite paste may be dried and then pressed or the like.

Housing the nonaqueous electrolyte in the case can be appropriately selected from publicly known methods. For example, in the case of using a nonaqueous electrolyte solution for the nonaqueous electrolyte, the nonaqueous electrolyte solution may be injected from an inlet formed in the case, followed by sealing the inlet.

The manufacturing method may include initially charging and discharging an uncharged and undischarged nonaqueous electrolyte energy storage device including a positive electrode, a negative electrode, and a nonaqueous electrolyte. In this initial charge-discharge, charge is performed in a range in which the positive electrode potential (positive electrode achieved potential) is less than 4.5 V vs. Li/Li⁺. Since the high potential formation is not performed, in the nonaqueous electrolyte energy storage device obtained through such initial charge-discharge, the capacity retention ratio after a charge-discharge cycle becomes higher. In the manufacturing method, the initial charge-discharge does not actively activate the positive active material (lithium-excess-type active material), and may be performed, for example, for confirming the capacity. That is, the initial charge-discharge is simply charge-discharge performed for the first time after assembling the uncharged and undischarged nonaqueous electrolyte energy storage device. The number of times of charge and discharge in the initial charge-discharge may be one or two, or may be three or more.

The upper limit of the positive electrode potential (positive electrode achieved potential) at the time of charging in the initial charge-discharge may be less than 4.45 V vs. Li/Li⁺ or less than 4.4 V vs. Li/Li⁺. On the other hand, the lower limit of the positive electrode potential (positive electrode achieved potential) at the time of charging in the initial charge-discharge is not particularly limited, and may be, for example, 4.25 V vs. Li/Li⁺ or more, 4.3 V vs. Li/Li⁺ or more, or 4.35 V vs. Li/Li⁺ or more.

### OTHER EMBODIMENTS

The positive electrode for a nonaqueous electrolyte energy storage device and the nonaqueous electrolyte energy storage device of the present invention are not limited to the embodiment mentioned above, and various changes may be made without departing from the gist of the present invention. For example, to the configuration of one embodiment, the configuration of another embodiment can be added, and a part of the configuration of one embodiment can be replaced by the configuration of another embodiment or a well-known technique. Furthermore, a part of the configuration according to one embodiment can be deleted. In addition, a well-known technique can be added to the configuration according to one embodiment.

In the embodiment, a case where the nonaqueous electrolyte energy storage device is used as a nonaqueous electrolyte secondary battery (for example, lithium ion secondary battery) that is chargeable and dischargeable has been described, but the type, shape, dimensions, capacity, and the like of the nonaqueous electrolyte energy storage device are arbitrary. The present invention can also be applied to various secondary batteries, and capacitors such as electric double layer capacitors and lithium ion capacitors.

While the electrode assembly with the positive electrode and the negative electrode stacked with the separator interposed therebetween has been described in the embodiment mentioned above, the electrode assembly may include no separator. For example, the positive electrode and the negative electrode may be brought into direct contact with each other, with a non-conductive layer formed on the active material layer of the positive electrode or negative electrode.

### EXAMPLES

Hereinafter, the present invention will be described in more detail with reference to Examples, but the present invention is not limited to the following Examples.

### Example 1

### (Fabrication of Positive Electrode)

As the first positive active material, LiNi_{0.5}Co_{0.2}Mn_{0.3}O₂ (average particle size: 4 μm) composed of primary particles (single-particle-based particle) that were not substantially aggregated was prepared. As the second positive active material, Li_{1.09}Ni_{0.36}Co_{0.13}Mn_{0.42}O₂ (average particle size: 13 μm) as secondary particles was prepared. The first positive active material and the second positive active material were mixed at a mixing ratio (mass ratio) of 50:50 to obtain a positive active material.

A positive composite paste containing the positive active material, acetylene black (AB), and polyvinylidene fluoride (PVDF) in a mass ratio of 90:5:5 in terms of solid content and containing N-methylpyrrolidone (NMP) as a dispersion medium was prepared. The positive composite paste was applied to a strip-shaped aluminum foil as a positive substrate, dried, and then roll-pressed to obtain a positive electrode.

### (Fabrication of Negative Electrode)

A negative composite paste containing graphite as a negative active material, styrene butadiene rubber (SBR), and carboxymethyl cellulose (CMC) at a mass ratio of 98:1:1 in terms of solid content and containing water as a dispersion medium was prepared. The negative composite paste was applied to a strip-shaped copper foil as a negative substrate, dried, and then roll-pressed to obtain a negative electrode.

### (Assembly of Uncharged and Undischarged Nonaqueous Electrolyte Energy

Storage Device) A wound electrode assembly was produced using the positive electrode, the negative electrode, and the separator. A polyolefin microporous membrane was used for the separator. An uncharged and undischarged nonaqueous electrolyte energy storage device was assembled by housing the electrode assembly and the nonaqueous electrolyte in a case. As a nonaqueous electrolyte, a nonaqueous electrolyte solution obtained by dissolving LiPF₆ at a content of 1.0 mol/dm³ in a nonaqueous solvent obtained by mixing ethylene carbonate (EC), ethyl methyl carbonate (EMC), and dimethyl carbonate (DMC) at a volume ratio of 30:35:35 was used.

### (Initial Charge-Discharge)

The obtained uncharged and undischarged nonaqueous electrolyte energy storage device was subjected to initial charge-discharge at 25° C. in the following manner. Constant current charge was performed up to 4.25 V (positive electrode achieved potential: 4.35 V vs. Li/Li⁺) at a charge current of 0.1 C, and then constant voltage charge was performed at 4.25 V. The end-of-charge condition was set at a time point at which the current decreased to 0.02 C. After a rest period of 10 minutes, constant current discharge was performed up to 2.5 V at a discharge current of 0.1 C, and a quiescent period of 10 minutes was provided. Subsequently, constant current charge was performed up to 4.25 V at a charge current of 1.0 C, and then constant voltage charge was performed at 4.25 V. The end-of-charge condition was set at a time point at which the current decreased to 0.05 C. After a rest period of 10 minutes, constant current discharge was performed up to 2.5 V at a discharge current of 1.0 C. A nonaqueous electrolyte energy storage device of Example 1 was obtained by the above procedure. The discharge capacity at the second cycle was defined as an initial discharge capacity.

In addition, with respect to the obtained nonaqueous electrolyte energy storage device of Example 1, X-ray diffraction measurement using a CuKα ray was performed on the positive electrode that was taken out in a state after initial charge-discharge and brought into fully discharged state by the above-described method. As a result, a diffraction peak was confirmed in the range of 20° or more and 22° or less.

### Examples 2 to 3 and Comparative Examples 1 to 4

Nonaqueous electrolyte energy storage devices of Examples 2 to 3 and Comparative Examples 1 to 4 were obtained similarly to Example 1 except that the types of the first positive active material and the second positive active material and the mixing ratio thereof were as shown in Table 1.

The mass per unit area of the solid content in the positive composite paste applied to the positive substrate was the same in all Examples and Comparative Examples. In all Examples and Comparative Examples, the number of windings of the positive electrode and the negative electrode was adjusted so that the size of the electrode assembly matched the size of the case, that is, the volumes of the electrode assembly were equal. That is, in each of Examples and Comparative Examples, a nonaqueous electrolyte energy storage device having the same volume including an electrode assembly having the same volume was produced.

### (Charge-Discharge Cycle Test)

Each nonaqueous electrolyte energy storage device was subjected to a charge-discharge cycle test at 45° C. in the following manner. Constant current charge was performed up to 4.25 V (positive electrode achieved potential: 4.35 V vs. Li/Li⁺) at a charge current of 1.0 C, and then constant voltage charge was performed at 4.25 V. The end-of-charge condition was set at a time point at which the current decreased to 0.05 C. Thereafter, constant current discharge was performed up to 2.75 V at a discharge current of 1.0 C. A rest period of ten minutes was provided after each of the charge and the discharge. Three hundred cycles were performed with this charge and discharge as one cycle.

For each nonaqueous electrolyte energy storage device after the charge-discharge cycle test, the discharge capacity was measured at 25° C. under the same conditions as in the second cycle of the initial charge-discharge, and the measured value was taken as the discharge capacity after the charge-discharge cycle. Then, the percentage of the discharge capacity after the charge-discharge cycle to the initial discharge capacity was obtained as the capacity retention ratio. The obtained initial discharge capacity and capacity retention ratio are shown in Table 1.

TABLE 1

| | Positive active material | | | | | | |
|---|---|---|---|---|---|---|---|
| | First positive active material | | Second positive active material | | | Initial | Capacity |
| | | Average | | Average | | discharge | retention |
| | | particle | | particle | Mixing ratio | capacity | ratio |
| | Kind | size [μm] | Kind | size [μm] | (Mass ratio) | [mAh] | [%] |
| Example 1 | LiNi_{0.5}Co_{0.2}Mn_{0.3}O₂ | 4 | Li_{1.09}Ni_{0.36}Co_{0.13}Mn_{0.42}O₂ | 13 | 50:50 | 200 | 95 |
| | (Single-particle-based particle) | | (Secondary particle) | | | | |
| Example 2 | LiNi_{0.5}Co_{0.2}Mn_{0.3}O₂ | 4 | Li_{1.09}Ni_{0.36}Co_{0.13}Mn0.₄₂O₂ | 13 | 20:80 | 198 | 95 |
| | (Single-particle-based particle) | | (Secondary particle) | | | | |
| Example 3 | LiNi_{0.5}Co_{0.2}Mn_{0.3}O₂ | 4 | Li_{1.09}Ni_{0.36}Co_{0.13}Mn_{0.42}O₂ | 13 | 80:20 | 198 | 95 |
| | (Single-particle-based particle) | | (Secondary particle) | | | | |
| Comparative | LiNi_{0.5}Co_{0.2}Mn_{0.3}O₂ | 13 | Li_{1.09}Ni_{0.36}Co_{0.13}Mn_{0.42}O₂ | 13 | 50:50 | 205 | 87 |
| Example 1 | (Secondary particle) | | (Secondary particle) | | | | |
| Comparative | LiNi_{0.5}Co_{0.2}Mn_{0.3}O₂ | 4 | — | — | 100:0 | 187 | 95 |
| Example 2 | (Single-particle-based particle) | | | | | | |
| Comparative | LiNi_{0.5}Co_{0.2} Mn_{0.3}O₂ | 13 | — | — | 100:0 | 202 | 84 |
| Example 3 | (Secondary particle) | | | | | | |
| Comparative | — | — | Li_{1.09}Ni_{0.36}Co_{0.13}Mn_{0.42}O₂ | 13 | 0:100 | 185 | 95 |
| Example 4 | | | (Secondary particle) | | | | |

As shown in Table 1, the nonaqueous electrolyte energy storage devices of Comparative Example 1 in which two kinds of positive active materials which are both secondary particles were used in combination and the nonaqueous electrolyte energy storage devices of Comparative Examples 2 to 4 in which only one kind of positive active material was used did not become excellent in both the initial discharge capacity and the capacity retention ratio after a charge-discharge cycle.

On the other hand, each of the nonaqueous electrolyte energy storage devices of Examples 1 to 3 obtained by combining the first positive active material which is a single-particle-based particle and has an average particle size of ½ or less of the average particle size of the second positive active material with the second positive active material which is a lithium-excess-type active material had a large initial discharge capacity and a high capacity retention ratio after a charge-discharge cycle. In Examples 1 to 3, the reason why the initial discharge capacity was increased by combining the first positive active material used in Comparative Example 2 and the second positive active material used in Comparative Example 4 is presumed to be that the filling rate of the formed positive active material layer was increased due to the difference in average particle size between the two types of positive active materials. In addition, since the electrode assembly and the nonaqueous electrolyte energy storage device were designed so as to have the same volume in each nonaqueous electrolyte energy storage device, it can be seen that the positive electrode provided in each nonaqueous electrolyte energy storage device of Examples 1 to 3 can increase the initial discharge capacity per volume of the nonaqueous electrolyte energy storage device.

### INDUSTRIAL APPLICABILITY

The present invention can be applied to a nonaqueous electrolyte energy storage device and the like used as a power source for electronic devices such as personal computers and communication terminals, automobiles, and industrial use and the like, a positive electrode thereof, and the like.

### DESCRIPTION OF REFERENCE SIGNS

1: Nonaqueous electrolyte energy storage device
2: Electrode assembly
3: Case
4: Positive electrode terminal
41: Positive electrode lead
5: Negative electrode terminal
51: Negative electrode lead
20: Energy storage unit
30: Energy storage apparatus

1. A positive electrode for a nonaqueous electrolyte energy storage device, the positive electrode comprising a first positive active material and a second positive active material having different constituent element compositions from each other,
wherein
the first positive active material is at least one of primary particles that are not substantially aggregated and secondary particles that are aggregated primary particles and have a ratio of an average particle size to an average primary particle size of 5 or less,
an average particle size of the first positive active material is ½ or less of an average particle size of the second positive active material, and
the second positive active material is a lithium transition metal composite oxide in which a content of a lithium element with respect to a transition metal element is more than 1.0 in terms of a molar ratio.

2. The positive electrode according to claim 1, wherein the first positive active material is a lithium transition metal composite oxide containing a nickel element.

3. The positive electrode according to claim 2, wherein a content of the nickel element with respect to the transition metal element in the first positive active material is 0.4 or more and 0.9 or less in terms of a molar ratio.

4. The positive electrode according to claim 1, wherein the second positive active material contains a nickel element and a manganese element as the transition metal element, and a content of the manganese element with respect to the transition metal elements is 0.4 or more and 0.8 or less in terms of a molar ratio.

5. The positive electrode according to claim 1, wherein the first positive active material has an average particle size of 3 μm or more and 5 μm or less, and the second positive active material has an average particle size of 10 μm or more and 15 μm or less.

6. A nonaqueous electrolyte energy storage device comprising the positive electrode according to claim 1.

7. The nonaqueous electrolyte energy storage device according to claim 6, wherein a diffraction peak is present in a range of 200 or more and 22° or less in an X-ray diffraction diagram of the positive electrode using a CuKα ray.

8. The nonaqueous electrolyte energy storage device according to claim 6, wherein a positive electrode potential at an end-of-charge voltage during normal usage is less than 4.5 V vs. Li/Li⁺.

9. An energy storage apparatus comprising: two or more nonaqueous electrolyte energy storage devices; and one or more nonaqueous electrolyte energy storage devices including the positive electrode according to claim 1.
